(19) United States
(12) Patent Application Publication
(10) Pub. No.: US 2011/0231528 A1
(43) Pub. Date: Sep. 22, 2011

(54) LANGUAGE SETTING DEVICE, METHOD FOR SETTING LANGUAGE OF LANGUAGE SETTING DEVICE, AND STORAGE MEDIUM HAVING STORED THEREIN LANGUAGE SETTING PROGRAM

(75) Inventor: Hideki Ishii, Nagoya-shi (JP)

(73) Assignee: BUFFALO INC., Nagoya-shi (JP)

(21) Appl. No.: 13/046,779

(22) Filed: Mar. 14, 2011

(30) Foreign Application Priority Data
Mar. 16, 2010 (JP) 2010-058720

(51) Int. Cl. G06F 15/177

(52) U.S. Cl. 709/220

(57) ABSTRACT

A language setting device 10 is configured to be able to support a large number of languages with a small storage capacity. The language setting device 10 includes: a storage section 13 for storing language data; a language code obtaining section 11 for obtaining via a network a language code indicating the language environment used in an online device 20, a language data obtaining section 12 for obtaining, from a language data storage server via the network, language data for setting the language environment of the language setting device so as to correspond to the language code, and for storing the obtained language data into the storage section 13; and a language environment setting section 14 for setting the language environment of the language setting device by using the language data stored in the storage section 13.

### CROSS REFERENCE TO RELATED APPLICATION

The disclosure of Japanese Patent Application No. 2010-058720 filed on Mar. 16, 2010 is incorporated herein by reference.

### BACKGROUND OF THE INVENTION

1. Field of the Invention

The present invention relates to language setting devices, which are online devices such as routers, for enabling their language environments to be set.

2. Description of the Background Art

Routers whose operation parameters can be set by computers connected to the routers are known (see, for example, the operation manual for a router sold under the trademark “TransCube” (manufactured by Toshiba Corp.) http://www3.toshiba.co.jp/pc/catalog/whms/manupdf/mp1063a3.pdf). In this case, a computer accesses the router via a network. And the router reads setting-window data described in a predetermined language, and transmits the window image data to the computer. The computer displays the setting window based on the transmitted image data. Generally, the predetermined language is the language that is used in a country where the router is sold. In situations in which router manufacturers export routers to a plurality of foreign countries, the manufacturers have manufactured multiple types of routers, with each router destined to a particular foreign country including language data corresponding to a language specification applicable to the country. Alternatively, manufacturers have manufactured routers in such a way that each router stores therein language data for several different languages, and thus language data for a given language can be selected from among the data for the several different languages upon initial start-up of the router.

In the former case, the router manufacturer needs to manufacture multiple types of routers to be adaptable for use in every export destination country, which reduces manufacturing efficiency. In the latter case, since the routers must store data for multiple languages, the router must have a large-capacity memory. These problems are not only shared by routers, but also by various electronic devices whose language environments are set by the user.

### SUMMARY OF THE INVENTION

Therefore, objects of the present invention are to solve at least a part of the above-described problems, and to realize language setting devices that can support a large number of languages with a smaller amount of storage capacity.

In order to achieve the above-described objects, the present invention is provided with the following features. A first aspect of the present invention is directed to a language setting device connectable to a network for enabling its language environment to be set, the device comprising: a language code obtaining section configured to obtain from an online device connected to the network a language code indicating what language environment the online device uses; a language data obtaining section configured to obtain, from a language data storage server in the network, language data for configuring the language setting device to have a language environment corresponding to the language code obtained by the language code obtaining section; a storage section configured to store the language data obtained by the language data obtaining section; and a language environment setting section configured to use the language data stored in the storage section to set the language environment of the language setting device.

In a further aspect, the network includes a LAN and an internet, the language setting device is connected to both the LAN and the internet, and the language data storage server is connected to at least one of either the internet or the LAN. The language data obtaining section is further configured: to search either the internet network or the LAN network for the language data storage server; if the language data obtaining section has found the language data storage server in the one network, to obtain the language data from the language data storage server having been found; to search the other network for the language data storage server if the language data obtaining section has not found the language data storage server in the one network; and when the language data obtaining section has found the language data storage server in the other network, to obtain the language data from the language data storage server having been found.

In a further aspect, the language setting device comprises a language data transmitting section for transmitting language data to another language setting device on the or the LAN.

In a further aspect, the language setting device comprises a Web server communication function using the World-Wide Web, and the language code obtaining section is further configured to obtain, from an online device accessing the Web server via a Web browser, a language code indicating in what language environment the Web browser operates.

Further, a second aspect of the present invention is directed to a method for setting the language of an language setting device connected to a network, with the method comprising: obtaining from an online device connected to the network a language code indicating what language environment the online device uses; obtaining, from a language data storage server in the network, language data for configuring the language setting device to have a language environment corresponding to the language code obtained by the language code obtaining section; and setting the language environment of the language setting device to have the language environment the online device uses, based on the obtained language data.

Further, a third aspect of the present invention is directed to non-transitory storage medium having stored therein a language setting program for setting language of a language setting device connected to a network, and the program causes a computer provided in the language setting device to execute the steps of: obtaining from an online device connected to the network a language code indicating what language environment the online device uses; obtaining, from a language data storage server in the network, language data for configuring the language setting device to have a language environment corresponding to the language code obtained by the language code obtaining section; and setting the language environment of the language setting device to have the language environment the online device uses, based on the obtained language data.

The language setting device according to the present invention obtains a language code from a language data storage server connected to a network. Thus, a language setting device that can support a large number of languages with a smaller amount of storage capacity can be realized.

### BRIEF DESCRIPTION OF THE DRAWINGS

FIG. 1 is a diagram illustrating a network system according to a first embodiment;

FIG. 2 is a block diagram illustrating the internal configuration of a router 10;

FIG. 3 is a flowchart of operation of the router 10 when the router has detected an access from a language setting device;

FIG. 4 is a block diagram illustrating the internal configuration of a router 10a according to a first modification of the first embodiment;

FIG. 5 is a flowchart of operation of the router 10a when the router has detected an access from a language setting device;

FIG. 6 is a block diagram illustrating the internal configuration of a router 10b according to a second modification of the first embodiment;

FIG. 7 is a flowchart of operation of the router 10b when the router has detected an access from a language setting device;

FIG. 8A is a diagram showing data flow through an intranet 40 when the router 10 detects access from a language setting device such as a computer 20;

FIG. 8B is a diagram showing data flow through an intranet 40 when the router 10 obtains a language code from a language setting device such as the computer 20;

FIG. 8C is a diagram showing data flow through networks when the router 10b obtains language data from an internet server 50;

FIG. 8D is a diagram showing data flow through an intranet 40 when the router 10b obtains language data from an intranet server 30;

FIG. 9 is a system configuration diagram of the router 10;

FIG. 10 is a system configuration diagram of the computer 20;

FIG. 11 is a system configuration diagram of the intranet server 30;

FIG. 12 is a system configuration diagram of the internet server 50;

FIG. 13 is a diagram illustrating a network system according to a second embodiment;

FIG. 14 is a block diagram illustrating the internal configuration of a router 10d;

FIG. 15 is a flowchart of part of operation of a NAS according to the second embodiment;

FIG. 16A is a diagram showing data flow through an intranet 40 when the NAS initially accesses a language setting device such as the router 10d;

FIG. 16B is a diagram showing data flow through an intranet 40 when the NAS obtains language data from the router 10d;

FIG. 17 is a system configuration diagram of the router 10d;

FIG. 18 is a system configuration diagram of a NAS 70c;

FIG. 19 is a diagram showing a network system according to a modification of the second embodiment; and

FIG. 20 is a system configuration diagram of a media server.

### DESCRIPTION OF THE PREFERRED EMBODIMENTS

### First Embodiment

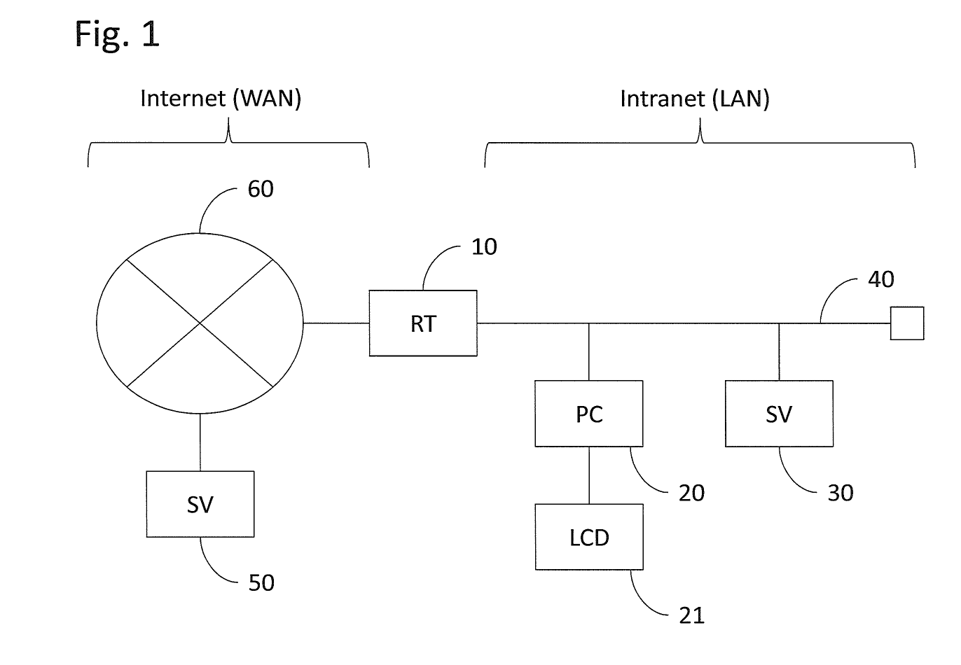

FIG. 1 is a diagram illustrating a network system according to a first embodiment. The network system includes an intranet 40 (also referred to as a LAN: Local Area Network), and an internet 60 (also referred to as a WAN: Wide Area Network). A router 10 is arranged between the intranet 40 and the internet 60. The router 10 is designed to relay data between the intranet 40 and the internet 60.

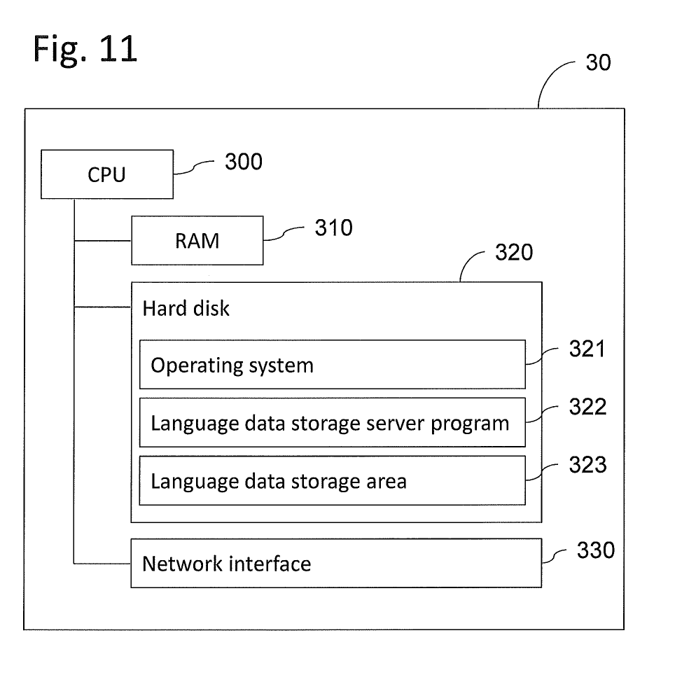

To the intranet 40, a computer 20, and an intranet server 30 (a language data storage server) are connected. To the computer 20, a display 21 is connected. The intranet server 30 is, for example, installed by a manufacturer of the router 10, or installed by an intranet administrator who is provided with a language data storage server program (to be described below with reference to FIG. 11) by the manufacturer of the router 10. Other than the devices (computer 20 and intranet server 30) shown in FIG. 1, various devices (online devices) can be connected to the intranet 40. In this embodiment, various devices connectable to networks will be collectively referred to as online devices. Therefore, examples of such online devices include, in addition to computers and servers, various apparatuses such as network attached storage (NAS), wireless HUBs, media servers, device servers, print servers, digital photo frames, network cameras, and network recorders. To the internet 60, an internet server 50 (language data storage server) is connected. The internet server 50 is, for example, installed by the manufacturer of the router 10.

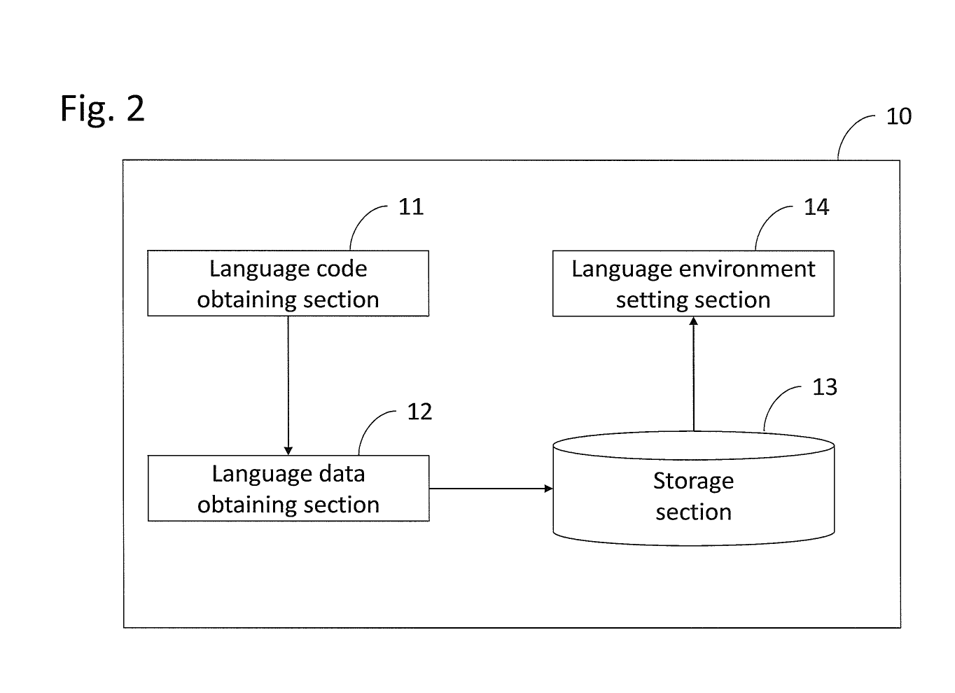

FIG. 2 is a block diagram illustrating an internal configuration of the router 10. The router 10 is composed of a language code obtaining section 11, a language data obtaining section 12, a storage section 13, and a language environment setting section 14. Hereinafter, a device which has the same configuration as the router 10, and is configured to set its language environment is referred to as “language setting device”.

The language code obtaining section 11 obtains, from an online device such as the computer 20 which has accessed the router 10, a language code indicating the language environment used in the online device. The language code can be obtained from an operating system or a Web browser of the online device.

The language data obtaining section 12 obtains language data stored in the language data storage server that either the intranet server 30 or internet server 50 is configured as. Here, the language data includes font data of the language. The language data may include hypertext data for generating character strings to be displayed on a screen for setting or operating the router 10. The language data obtaining section 12 preferentially accesses either the intranet server 30 or internet server 50.

The storage section 13 stores therein language data obtained by the language data obtaining section 12.

The language environment setting section 14 sets the language environment of the router 10 so as to operate the router 10 under a language environment according to the language data stored by the storage section 13.

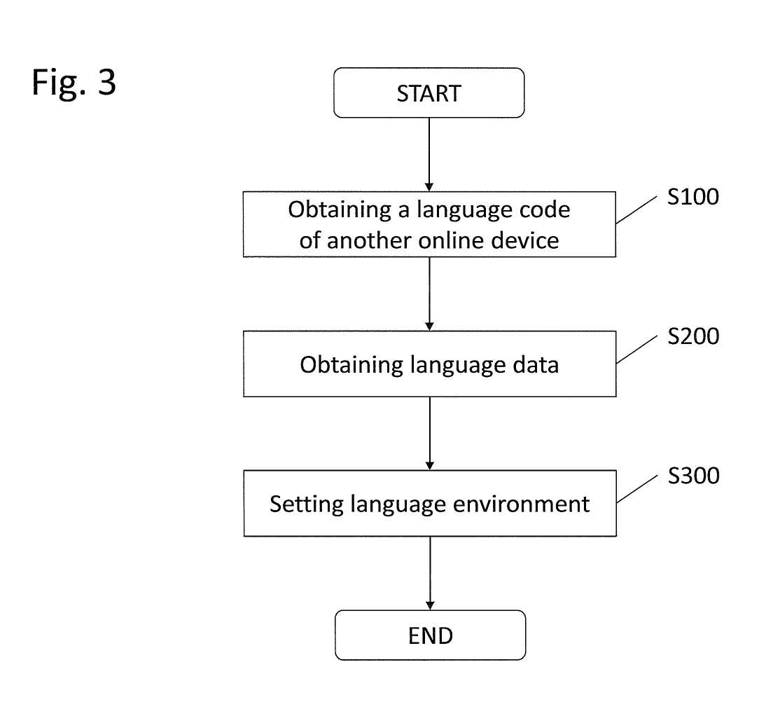

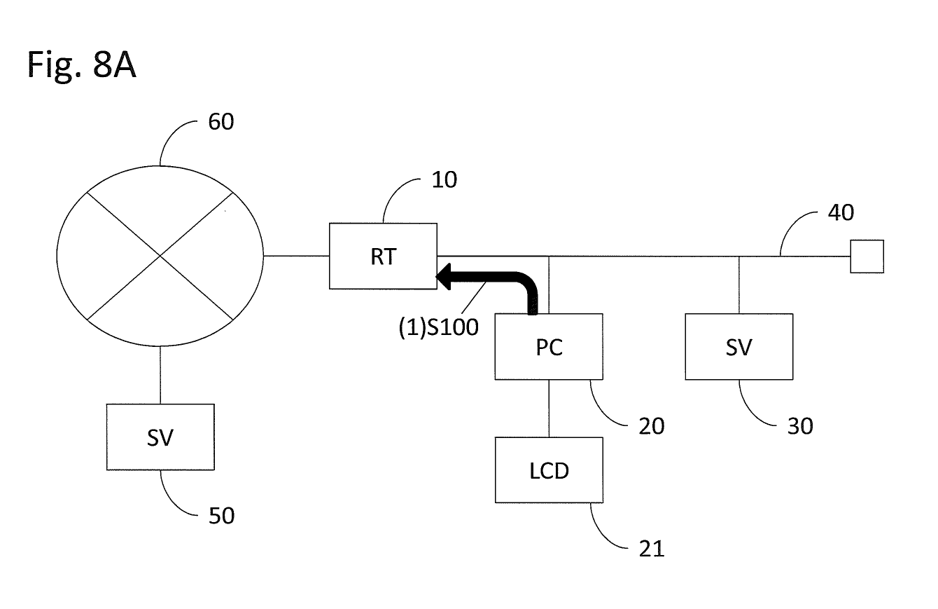

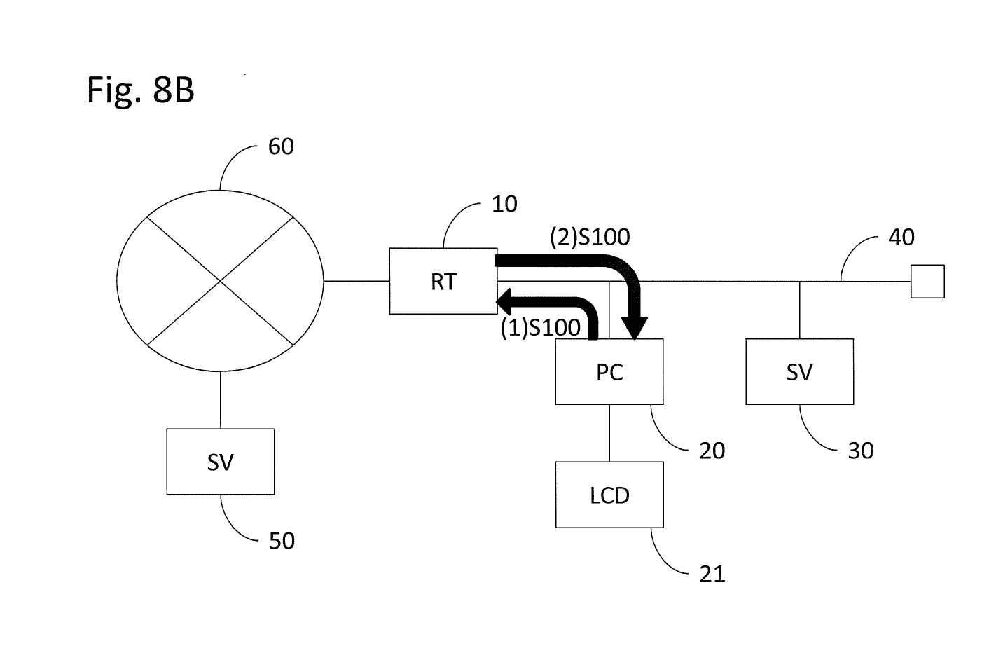

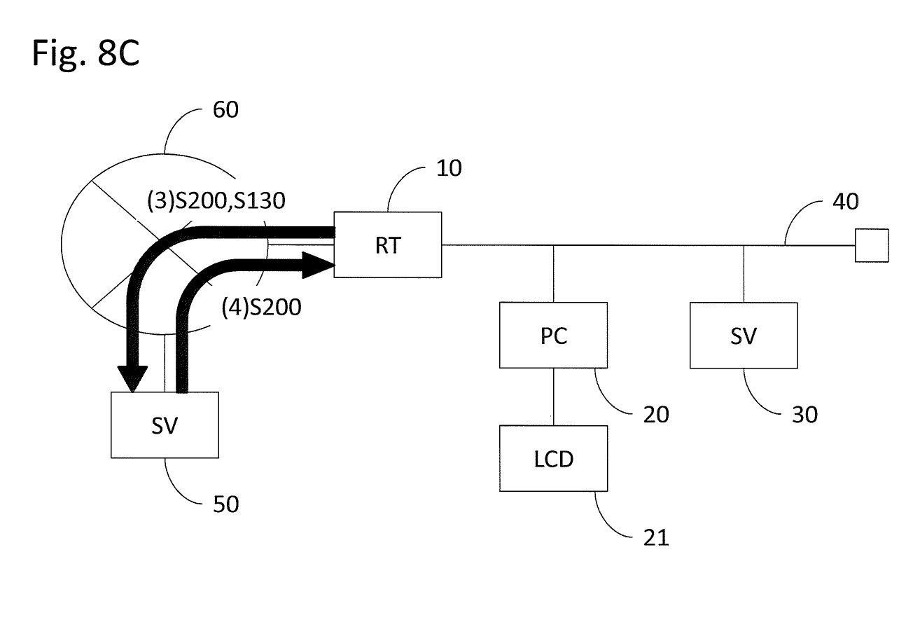

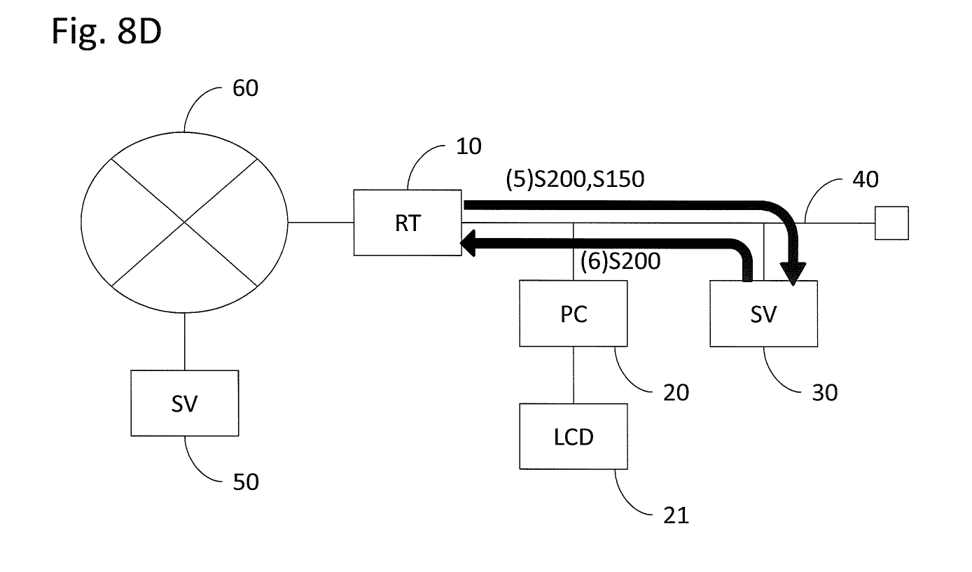

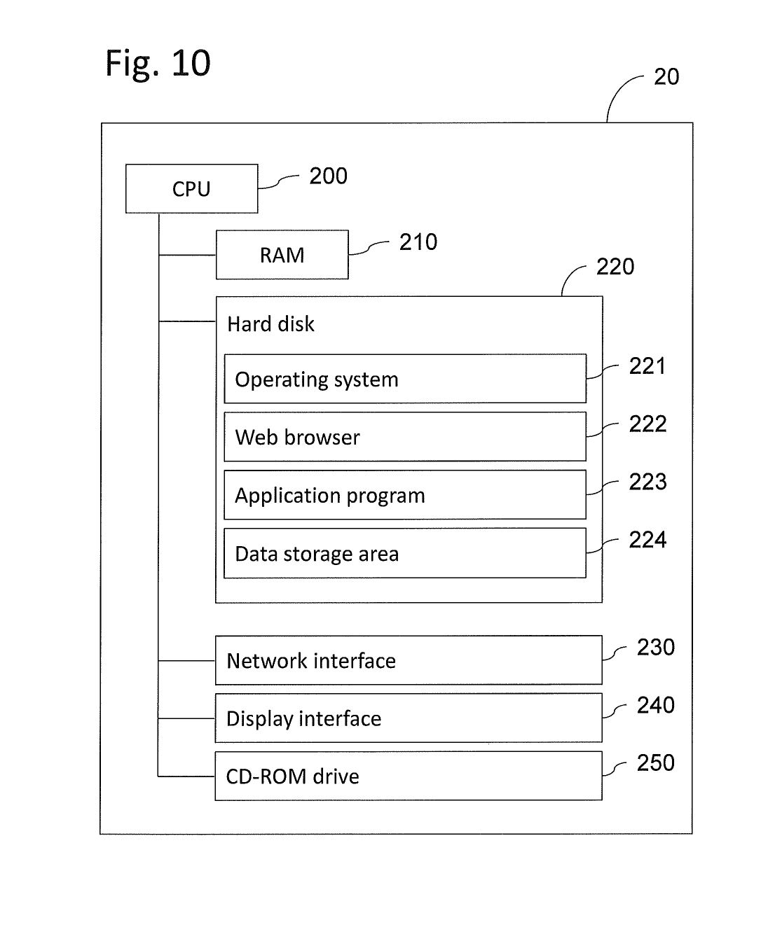

Next, operation of the router 10 of this embodiment will be described in detail with reference to the drawings. FIGS. 8A to 8D are diagrams each illustrating data flow through a network during language environment setup. FIG. 3 is a flowchart showing operation of the router 10 of this embodiment when the router 10 has detected an access thereto by an online device such as the computer 20 (see FIG. 8A). The access may be, for example, made by a Web browser 222 (to be described below with reference to FIG. 10).

In step S100, the language code obtaining section 11 obtains a language code indicating the language environment used in the online device (see FIG. 8B). If the other online device is the computer 20, the language code obtaining section 11 can obtain the language code from an operating system (OS) 221 or Web browser 222 (to be described below with reference to FIG. 10) of the computer 20.

In step S200, the language data obtaining section 12 searches for the language data storage server (see (3) in FIG. 8C or (5) in FIG. 8D). When having found the language data storage server, the language data obtaining section 12 obtains language data from the language data storage server (see (4) in FIG. 8C or (6) in FIG. 8D). The language data obtaining section 12 then stores the obtained language data into the storage section 13.

In step S300, the language environment setting section 14 updates the language environment of the router 10 to the language environment according to the language data stored in the storage section 13.

Then, the router 10 performs the following processes as necessary. To begin with, the router 10 generates setting window image data which corresponds to a current language environment of the router 10 and which is displayable by the Web browser 222 of the computer 20 or the like (to be described below with reference to FIG. 10). Next, the router 10 transmits the generated setting image data to the computer 20.

As described above, according to this embodiment, to change an initially set language environment to a different language environment, the router 10 obtains language data from the language data storage server (internet server 50 or intranet server 30) which is connected to the network (internet 60 or intranet 40). Therefore, the manufacturer of the router 10 only needs to store any one item of language data into the storage section 13 during manufacturing irrespective of the language environment by the user of the router will use. Therefore, the manufacturer need not necessarily manufacture two or more types of routers depending on the languages used in the exporting countries. In addition, the storage capacity of the storage section 13 can be reduced. Namely, a router 10 that can support a large number of languages with a smaller storage capacity can be realized.

(Modification)

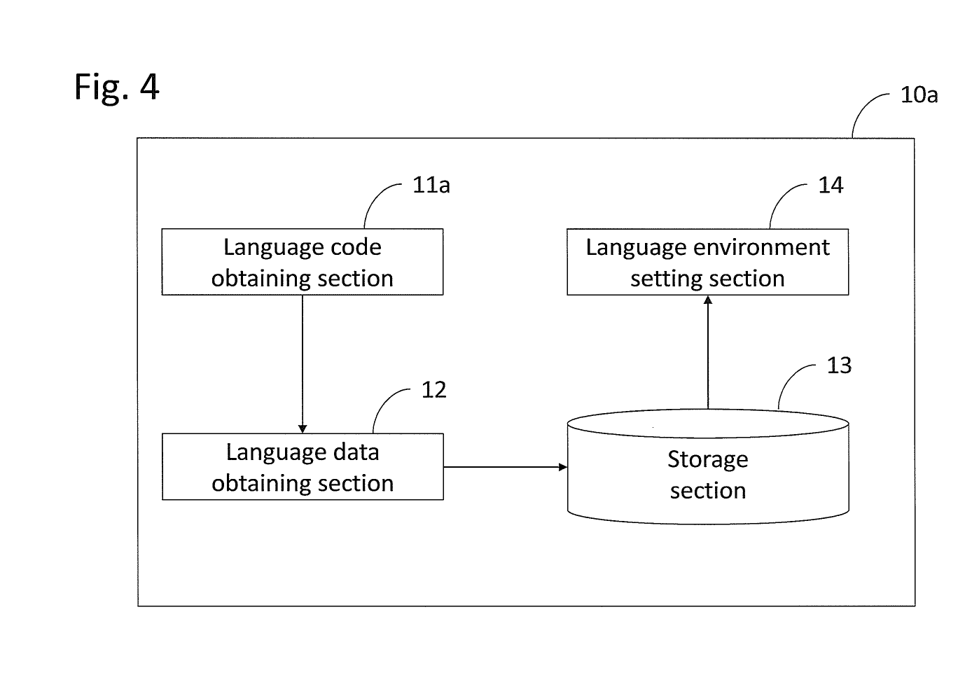

Next, a modification of the present embodiment will be described in detail with reference to the drawings. FIG. 4 is a block diagram illustrating the internal configuration of a router 10a according to a first modification of the present embodiment. The router 10a is partially different from the router 10 in FIG. 2 in terms of the function of the language code obtaining section 11. Hereinafter, the language code obtaining section in this modification is referred to as a language code obtaining section 11a.

The language code obtaining section 11a has, in addition to the function held by the language code obtaining section 11, a function of determining whether a language code obtained from an online device coincides with the language code the router 10a currently uses. If these language codes coincide with each other, the language code obtaining section 11a controls the language data obtaining section 12 not to obtain language data from the language data storage server.

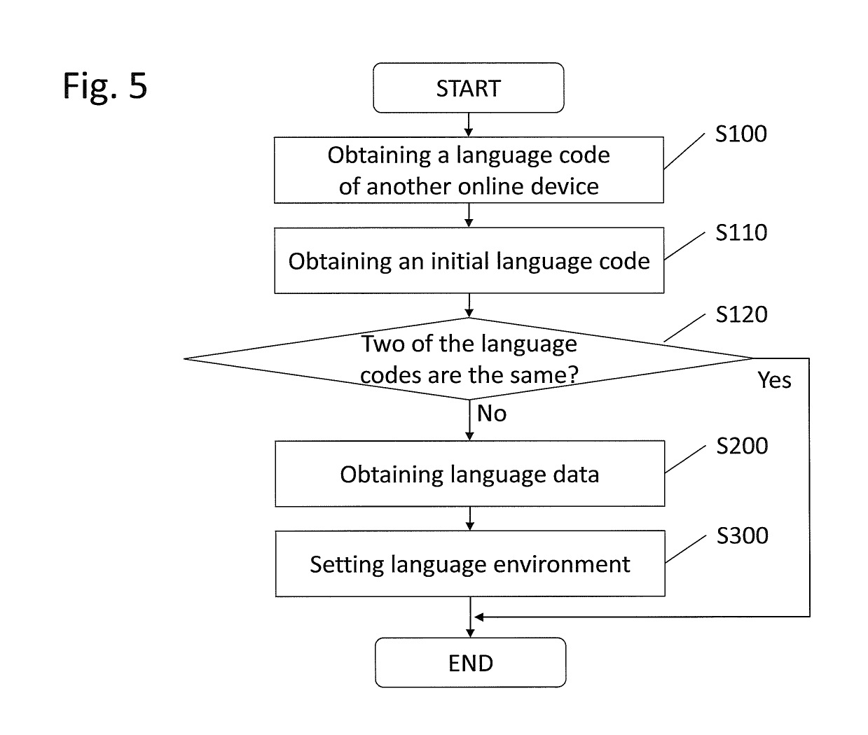

Next, operation of the router 10a of this modification will be described in detail with reference to FIG. 5. FIG. 5 is a flowchart showing the operation of the router 10a of this modified embodiment performed during language environment setup. In this flowchart, processes that are the same as those in FIG. 3 are denoted by the same reference numerals, respectively, and no explanation thereof will be given.

In step S110, the language code obtaining section 11a obtains the language code indicating the initial language environment of the router 10a. Here, the language code indicates the language that the router 10a is initially set to. The manufacturer of the router 10a can set any language as the initially set language. The language may be, for example, the official language used in the country where the manufacturer of the router 10a is located.

In step S120, the language code obtaining section 11a determines whether the language code indicating the language environment initially set to the router 10a coincides with the language code obtained from an online device such as the computer 20 or the like. If they coincide with each other, the router 10a ends the process, whereas if they do not coincide with each other, the router 10a advances the processing to step S200.

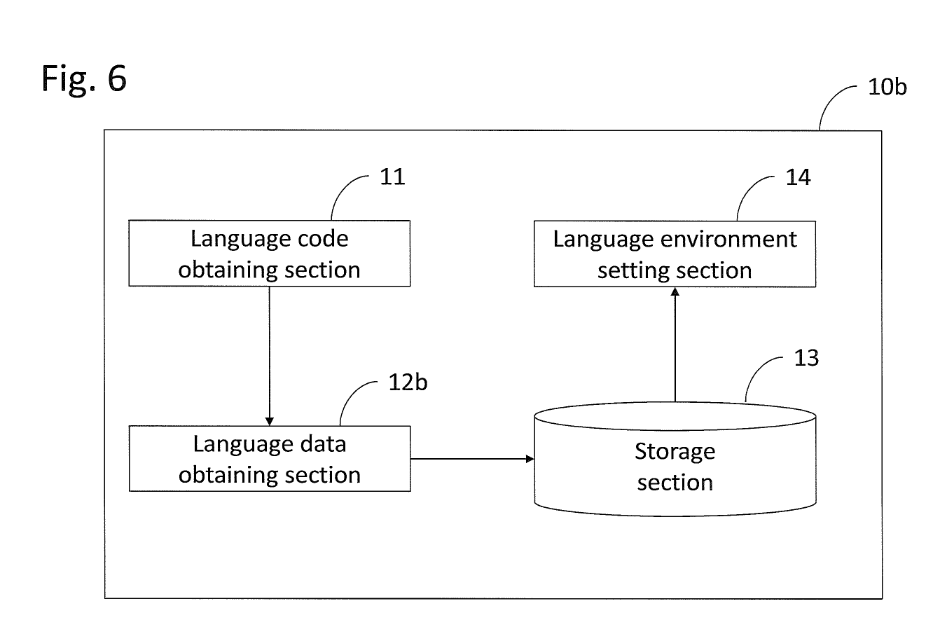

Next, another modification of the present embodiment will be described in detail with reference to the drawings. FIG. 6 is a block diagram illustrating the internal configuration of a router 10b according to a second modification of the present embodiment. The router 10b is partially different from the router 10 in FIG. 2 in terms of the function of the language data obtaining section 12. Hereinafter, the language data obtaining section of this modification is referred to as a language data obtaining section 12b.

The language data obtaining section 12b searches for a language data storage server (internet server 50) on the internet 60, and a language data storage server (intranet server 30) on the intranet 40, in this order. The language data obtaining section 12b then obtains language data from the language data storage server that is determined to be able to supply language data readily.

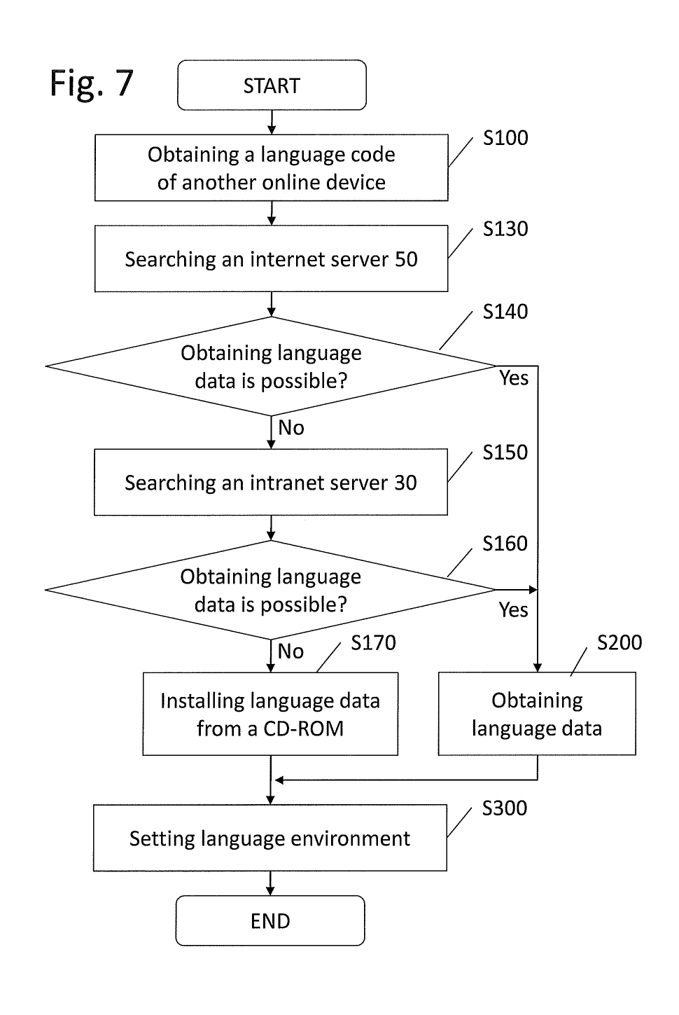

Next, operation of the router 10b of this modification will be described in detail with reference to the drawings. FIGS. 8A to 8D are diagrams each illustrating a data flow through a network during language environment setup. FIG. 7 is a flowchart showing the operation of the router 10b of this modified embodiment when the router 10b has detected an access thereto by an online device such as the computer 20 or the like (see FIG. 8A). In this flowchart, the processes that are the same as those in FIG. 3 are denoted by the same reference numerals, respectively, and no explanation thereof will be given.

In step S130, the language data obtaining section 12b searches for an internet server 50 (language data storage server) on the internet 60 (see (3) in FIG. 8C). Usually, an internet server 50 for transmitting language data is furnished by the manufacturer of the router 10b, and the address of the internet server 50 is stored in advance in the router 10b. In step S140, the language data obtaining section 12b determines whether language data can be obtained from the internet server 50. If the language data can be obtained, the language data obtaining section 12b performs the process in step S200, and obtains the language data from the internet server 50 (see (4) in FIG. 8C). The language data obtaining section 12b then stores the obtained language data into the storage section 13. Thereafter, the language environment setting section 14 performs the process in step S300. If the language data cannot be obtained, the language data obtaining section 12b performs the process in step S150. Situations where the language data cannot be obtained indicate, for example, cases where the internet server 50 is under maintenance, or cases where some communication failure has occurred on the internet 60.

In step S150, the language data obtaining section 12b searches for the intranet server 30 (language data storage server) on the intranet 40 (see (5) in FIG. 8D). The language data obtaining section 12b searches for the intranet server 30 by unicasting or broadcasting a command, obtaining the version of the OS in the online device that replies to the command, and based on the OS identifying the intranet server 30. Accordingly, the language data obtaining section 12b can specify the intranet server 30. In step S160, the language data obtaining section 12b determines whether it is possible to obtain language data from the intranet server 30. If it is possible to obtain the language data, the language data obtaining section 12b performs the process in step S200, thereby to obtain the language data from the intranet server 30 (see (6) in FIG. 8D). The language data obtaining section 12b stores the obtained language data into the storage section 13. Thereafter, the language environment setting section 14 performs the process in step S300. If it is not possible to obtain the language data, the language data obtaining section 12b performs the process in step S170. Situations where the language data cannot be obtained indicate, for example, cases where the intranet server 30 is under maintenance, or cases where some communication failure has occurred on the intranet 40.

In step S170, the language data obtaining section 12b requests installation of language data from a CD-ROM, and obtains the language data from the CD-ROM inserted into a CD-ROM drive of the computer 20. The language data obtaining section 12b stores the obtained language data into the storage section 13. Thereafter, the language environment setting section 14 performs the process in step S300.

In this modification, the language data obtaining section 12b firstly searches for the language data storage server 50 on the internet 60, and then searches for the language data storage server 30 on the intranet 40. However, either of the language data storage servers may be searched for first. The manufacturer of the router 10b usually furnishes a language data storage server 50 on the internet 60. Thus, initially searching for the language data storage server 50 on the internet 60 makes it possible to obtain the latest language data. On the other hand, initially searching for the language data storage server 30 on the intranet 40 makes it possible to reduce load on the network, particularly on the internet.

It should be noted that, in this modification, when the language data is to be installed from a CD-ROM, a direction for requesting CD-ROM insertion is displayed by means of the default language of the router 10b. However, the router 10b may request CD-ROM insertion by displaying on the display 21 window image data in place of alphabetic data, without depending on the language environment. Further, for language selection, a map may be displayed on the display 21. In this case, a country on the map is selected for language selection.

Further, in this modification, the language data obtaining section 12b need not necessarily perform the process in step S170. Alternatively, the language data obtaining section 12b may perform merely an error display in step S170.

Further, the above-described two modifications may be utilized in a combined manner. Namely, the router may include the language code obtaining section 11a, the language data obtaining section 12b, the storage section 13, and the language environment setting section 14. Such a router is hereinafter referred to as a router 10c.

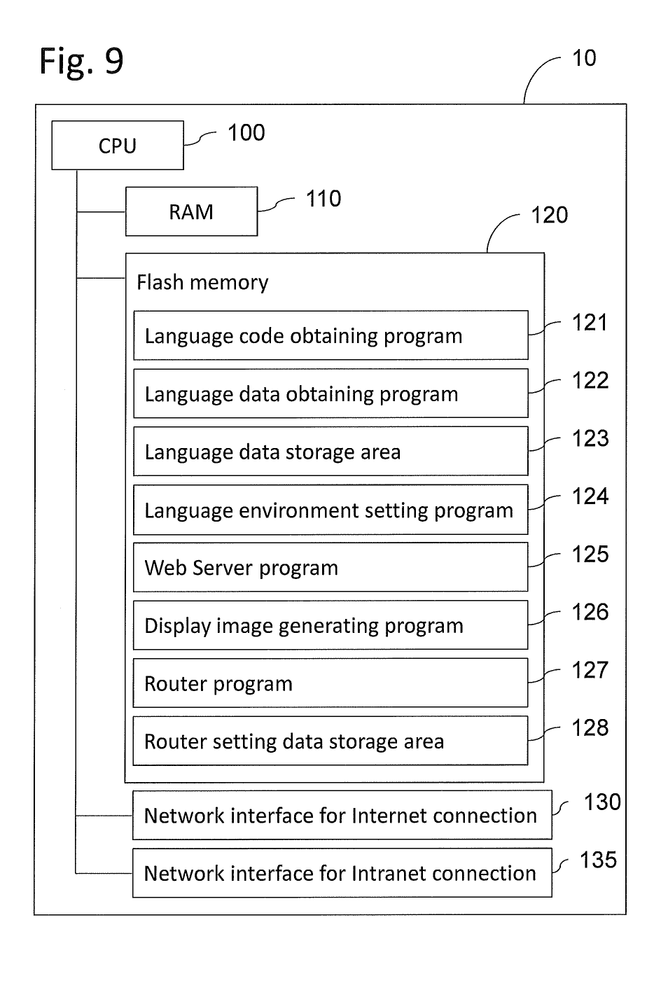

Next, a system configuration of the present embodiment will be described. FIG. 9 is a system configuration diagram of the router 10. The router 10 includes a CPU 100, a RAM 110, a flash memory 120, a network interface for internet connection 130, and a network interface for intranet connection 135. The flash memory 120 contains therein a language code obtaining program 121, a language data obtaining program 122, a language data storage area 123, a language environment setting program 124, a Web server program 125, a display image generating program 126, a router program 127, and router setting data storage area 128. These programs 121, 122, 124 to 127 are executed by the CPU 100 thereby to realize the functions of the router 10 as described below.

The language code obtaining program 121 executes the function of the language code obtaining section 11. The language data obtaining program 122 executes the function of the language data obtaining section 12. The language data storage area 123 has the same function as the storage section 13. The language environment setting program 124 executes the function of the language environment setting section 14.

The Web server program 125 adds to the router 10 a Web server function. Accordingly, the administrator of the intranet can access the router 10 from the computer 20 by means of the Web browser thereby to change settings of the router 10 or execute various operations on the router 10 by means of the computer 20. Further, the Web server program 125 transmits a display image, which is generated by the display image generating program 126 to be described below, to an online device such as the computer 20. The Web server program 125 may obtain, in association with the language code obtaining program 121, the language code used by the Web browser of the computer 20. Upon being accessed by means of the Web browser of the computer 20, the display image generating program 126 generates a display image in accordance with a new language environment set by the language environment setting program 124, thereby to be displayed on the screen of the Web browser.

The router program 127 causes the router 10 to function as a router. That is, the router program 127 realizes, for example, a packet-filtering function or an address conversion function between a global address for the internet 60 and a private address for the intranet 40. The router program 127 may be configured to have, in addition to the router function, various router-related functions such as a firewall function. The router setting data storage area 128 stores therein various setting parameters of the router 10 such as an address conversion table, and a packet filtering table. These functions are generally included in routers, and not related to technical features specific to the present invention. Thus, no detailed description will be given of these functions.

The system configurations of the routers 10a, 10b, and 10c are the same as that of the router 10 except for the language code obtaining program 121 and the language data obtaining program 122. The language code obtaining program 121 and the language data obtaining program 122 included in each of the routers 10a, 10b, and 10c may be realized by any programs as long as the programs execute the operations of the corresponding language code obtaining section and the language data obtaining section.

FIG. 10 is a system configuration diagram of the computer 20. The computer 20 includes a CPU 200, a RAM 210, a hard disk 220, a network interface 230, a display interface 240, and a CD-ROM drive 250. The hard disk 220 includes the OS 221, the Web browser 222, an application program 223, and a data storage area 224. These programs 221 to 223 are executed by the CPU 200, and thereby their functions are realized. The data storage area 224 is used, for example, to store a data file generated by execution of the application program 223. In this embodiment, although the computer 20 includes the hard disk 220 as a storage device, the computer 20 may include a Solid State Drive (SSD) in place of the hard disk 220.

FIG. 11 is a system configuration diagram of the intranet server 30. The intranet server 30 includes a CPU 300, a RAM 310, a hard disk 320, and a network interface 330. The hard disk 320 includes an OS 321, a language data storage server program 322, and a language data storage area 323. These programs 321 to 322 are executed by the CPU 300, and thereby their functions are realized. Upon the intranet server 30 being accessed by the router 10 through execution of the language data obtaining program 122, for example, the language data storage server program 322 transmits to the router 10 language data stored in the language data storage area 323.

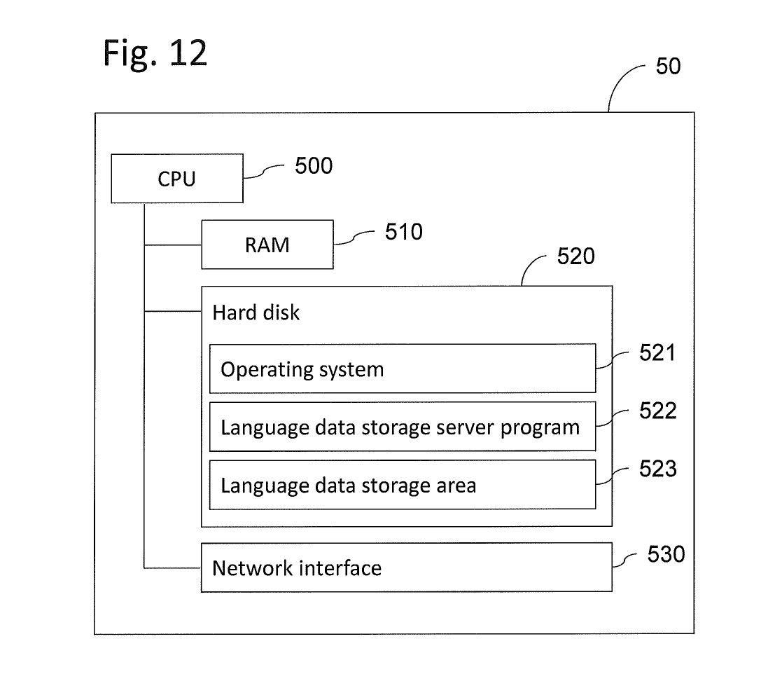

FIG. 12 is a system configuration diagram of the internet server 50. The internet server 50 has the same configuration as the intranet server 30 except that the network to which it is connected is the internet 60. Components included in the internet server 50 are denoted by reference numerals in the five hundreds, and no description thereof will be given.

In this embodiment and its modifications, the router has been described as an example of the language setting device. However, the technique of this embodiment is applicable to, other than the router, such devices as are connectable to a network, that is, it is applicable to a network attached storage (NAS), a media server, a device server, a print server, a digital photo frame, a network camera, a network recorder, and the like.

### Second Embodiment

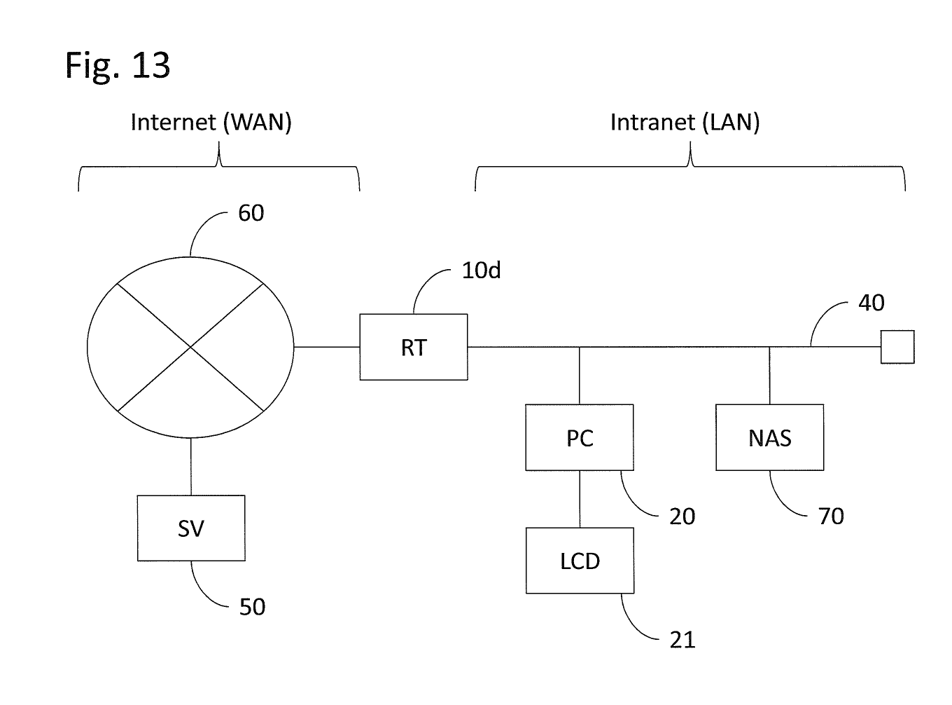

FIG. 13 is a diagram showing a network system according to a second embodiment. In the second embodiment, a router includes a language data storage server function. Hereinafter, the router including the language data storage server function is referred to as a router 10d. The network system of the second embodiment is different from that of the first embodiment in that a NAS 70 is connected to the intranet 40 and that the router 10d includes the language data storage server function. Here, an example of a case will be described where a language environment is set in the NAS 70.

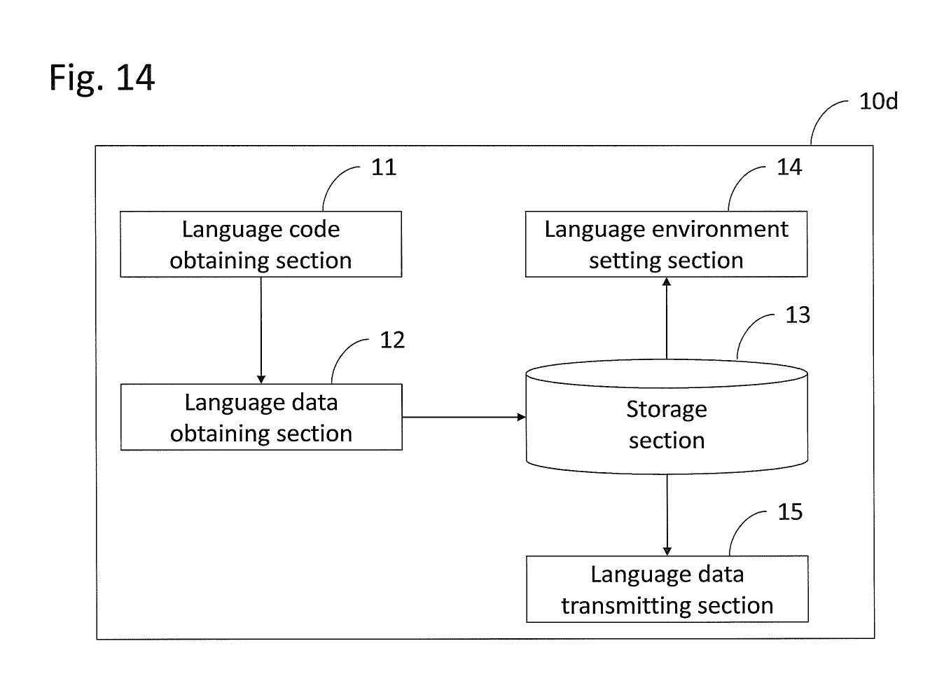

FIG. 14 is a block diagram illustrating an internal configuration of the router 10d. The router 10d is different from the router 10 of the first embodiment in that the router 10d further includes a language data transmitting section 15. The language data transmitting section 15 has a function equal to that of the language data storage server function. That is, upon an access to the router 10d by the NAS 70, the language data transmitting section 15 transmits to the NAS 70 language data stored in the storage section 13.

The NAS 70 has a configuration of any of the routers 10, 10a, 10b, and 10c of the first embodiment. Thus, the NAS 70 corresponds to the language setting device of the first embodiment. Hereinafter, for convenience of explanation, NAS's having the configurations of the routers 10, 10a, 10b, and 10c, respectively, of the first embodiment are referred to as NAS 70, 70a, 70b, and 70c. However, the operations of the language data obtaining sections included in NAS 70b and NAS 70c are partially different from that of the language data obtaining section 12b in the first embodiment. In the description hereinbelow, the language data obtaining section included in both the NAS 70b and NAS 70c is referred to as a language data obtaining section 12d, and description thereof will be given in detail. Since the remaining components are the same as those in the first embodiment, no description thereof will be given.

The language data obtaining section 12d searches for the router 10d, and determines whether the router 10d and the NAS were manufactured by the same manufacturer, and whether it is possible to obtain language data from the router 10d. If the router 10d and the NAS were manufactured by the same manufacturer and it is possible to obtain the language data from the router 10d, then the language data obtaining section 12d obtains the language data from the router 10d. Otherwise, the language data obtaining section 12d attempts to obtain language data from the internet server 50 or the like. The remaining functions of the language data obtaining section 12d are the same as those of the language data obtaining section 12b.

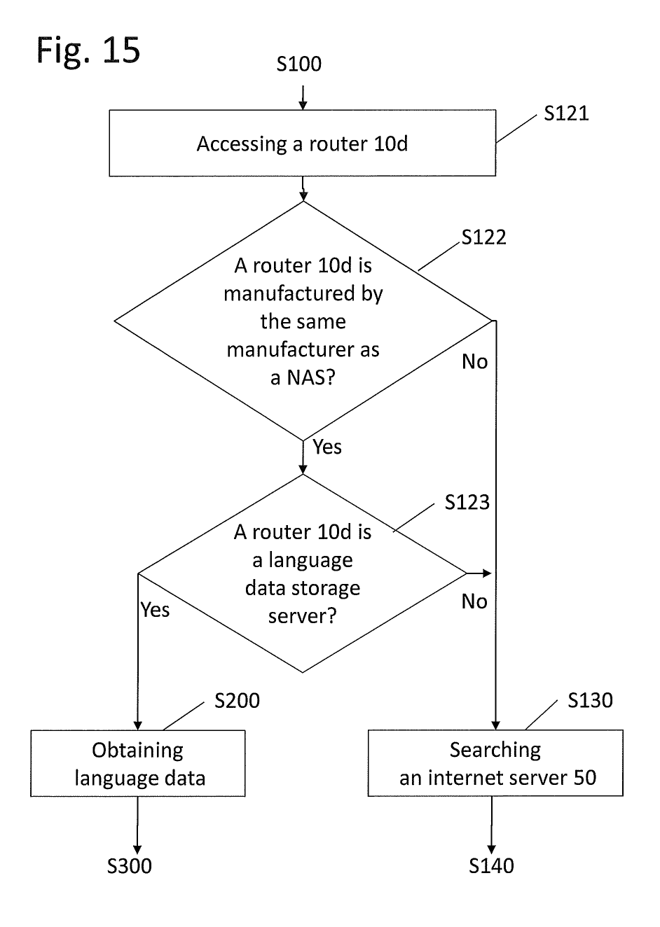

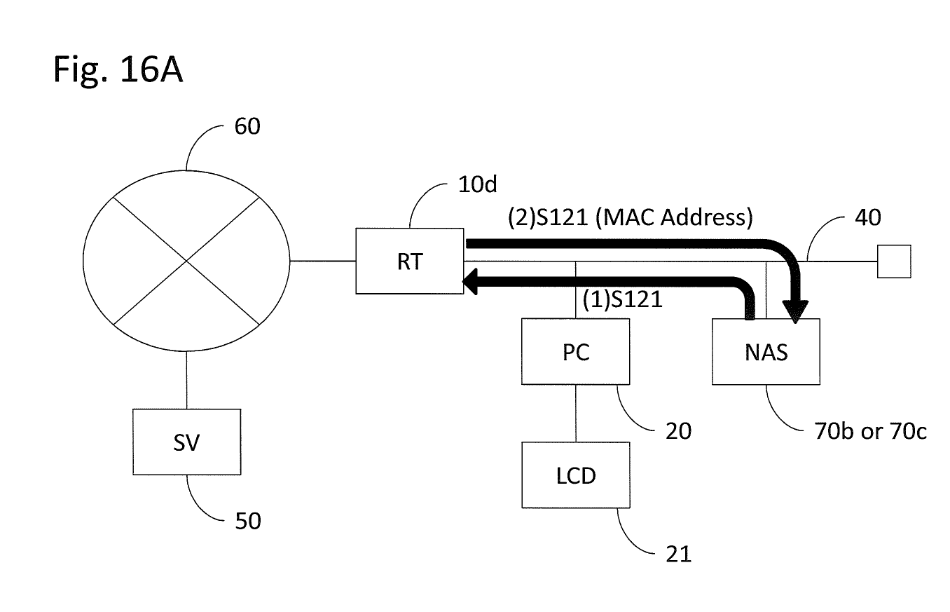

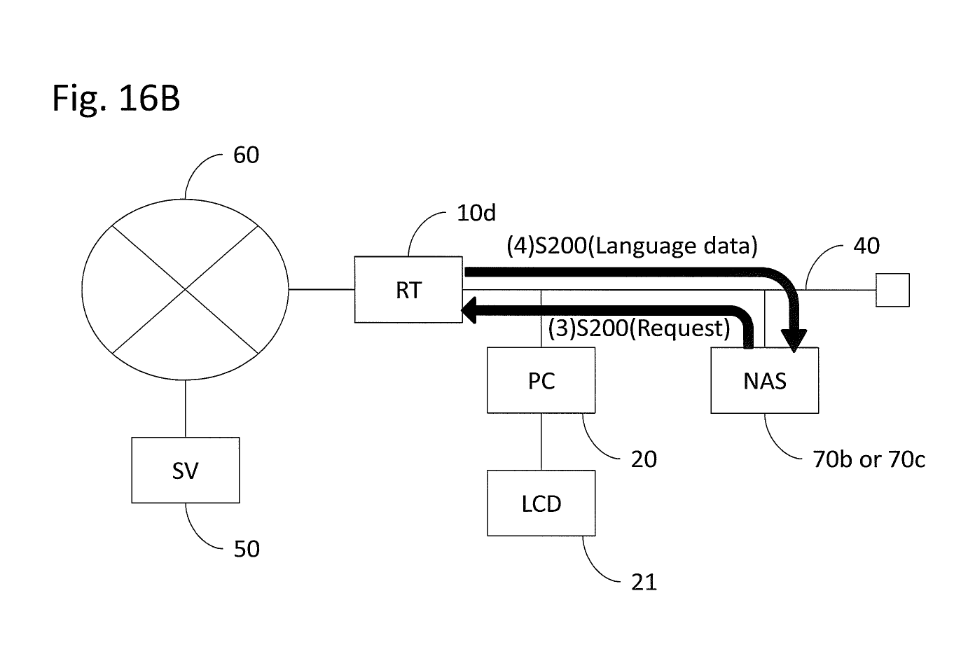

Next, the operations of the NAS and the router 10d according to the second embodiment will be described. In the case of the NAS 70 or NAS 70a, the NAS obtains, in step S200 in FIG. 3 and FIG. 5, language data from the router 10d, instead of from the language data storage server. In the case of the NAS 70b or NAS 70c, the NAS performs the processes shown in FIG. 15 after the process in step S100 in FIG. 7. FIG. 16A and FIG. 16B are diagrams each illustrating a flow of network data during language setting.

In the first embodiment, the language data obtaining section initially accesses the internet server 50 on the internet 60. However, in the second embodiment, the language data obtaining section 12d accesses the router 10d in step S121. The language data obtaining section 12d then obtains from the router 10d a media access control (MAC) address, for example (see FIG. 16A).

In step S122, the language data obtaining section 12d determines whether the NAS and the router 10d were manufactured by the same manufacturer. The MAC address is constituted by 48 bits, and the upper 24 bits indicate the manufacturer. Therefore, the language data obtaining section 12d compares the upper 24 bits of the MAC address of the NAS and the upper 24 bits of the MAC address of the router, thereby to determine whether the NAS and the router 10d were manufactured by the same manufacturer. If they are manufactured by different manufacturers, the language data obtaining section 12d performs the process in step S130. The processes performed by the NAS thereafter are the same as those in the first embodiment.

If they are manufactured by the same manufacturer, the language data obtaining section 12d advances the processing to step S123, and determines whether the router 10d can function as the language data storage server. For example, the language data obtaining section 12d sends a command for requesting language data to the router 10d. If language data is transmitted in response to the command, the language data obtaining section 12d obtains the language data in step S200 (see FIG. 16B). Thereafter, the router 10d advances the processing to step S300 in the first embodiment. Operation thereafter is the same as that in the first embodiment.

On the other hand, if language data is not transmitted within a predetermined period of time, the language data obtaining section 12d determines that the router 10d cannot function as the language data storage server. In this case, the language data obtaining section 12d performs the process in step S130. Operation of the NAS thereafter is the same as that in the first embodiment.

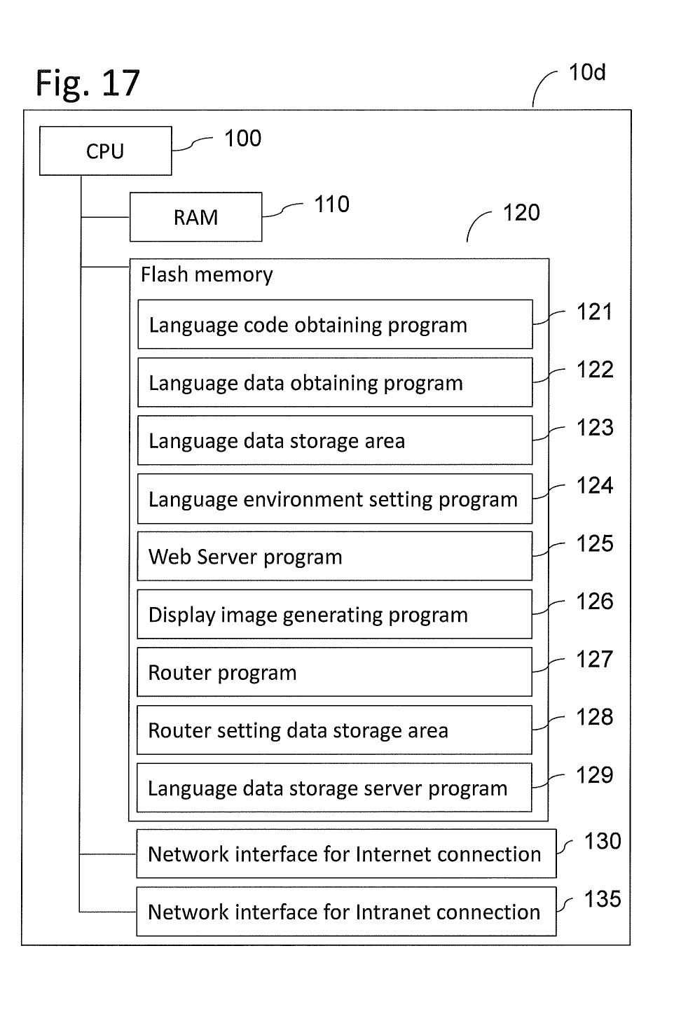

Next, a system configuration of this embodiment will be described. FIG. 17 is a system configuration diagram of the router 10d. The router 10d shown in FIG. 17 is different from the router 10c shown in FIG. 9 in that the flash memory 120 stores therein a language data storage server program 129. The function of the language data storage server program 129 is the same as that of the language data storage server program 322 stored in the hard disk 320 of the language data storage server 30.

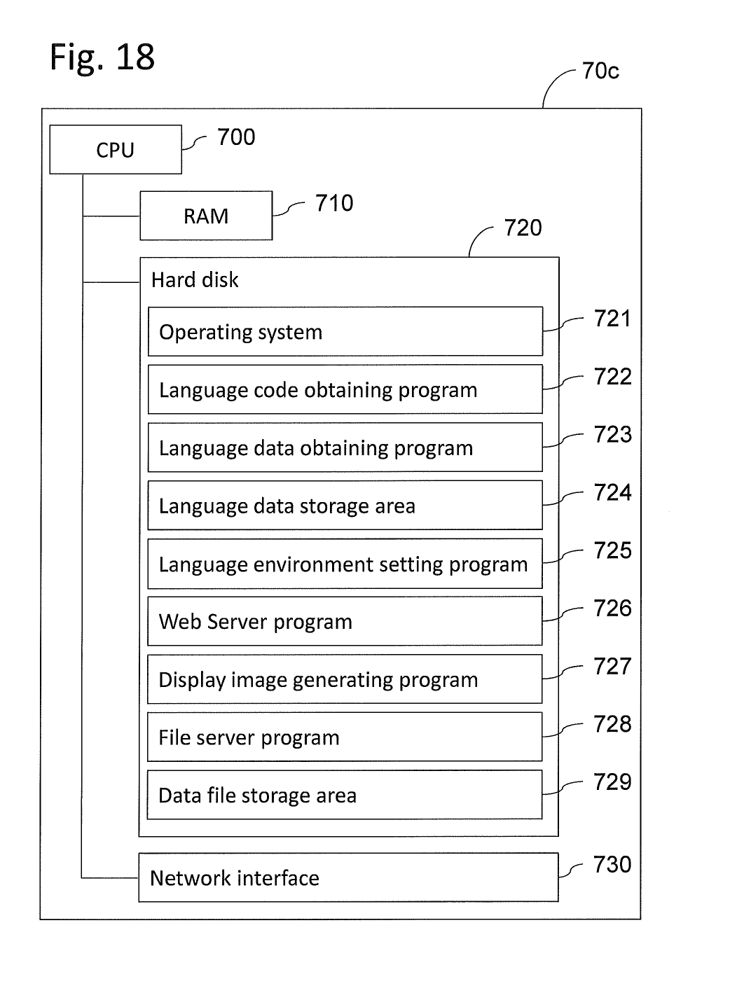

FIG. 18 is a system configuration diagram of the NAS 70c. The NAS 70 includes a CPU 700, a RAM 710, a hard disk 720, and a network interface 730. The hard disk 720 includes an OS 721, a language code obtaining program 722, a language data obtaining program 723, a language data storage area 724, a language environment setting program 725, a Web server program 726, a display image generating program 727, a file server program 728, and a data file storage area 729. These programs are executed by the CPU 700, to realize their functions. Here, the functions of the language code obtaining program 722, the language data storage area 724, the language environment setting program 725, the Web server program 726, and the display image generating program 727 are the same as the functions of the language code obtaining program 121, the language data storage area 123, the language environment setting program 124, the Web server program 125, and the display image generating program 126 of the router 10 in the first embodiment, respectively. Thus, no description will be given for these programs. The language data obtaining program 723 performs a process relating to the language data obtaining section 12d. The file server program 728 causes the NAS to function as a file server over a network. For example, the file server program 728 may include a redundant array of inexpensive disks (RAID) function, or a backup function. The data file storage area 729 is an area in which data files and the like are stored.

As described above, according to the second embodiment, the manufacturer of the NAS need not manufacture two or more types of NAS depending on the languages used in the exporting countries, as in the first embodiment. In addition, the storage capacity of the storage section 13 can be saved.

In the second embodiment, since the router 10d functions as the language data storage server, no provision of an intranet server 30 is required. In this case, steps S150 to S160 in FIG. 7 are not performed.

(Modification)

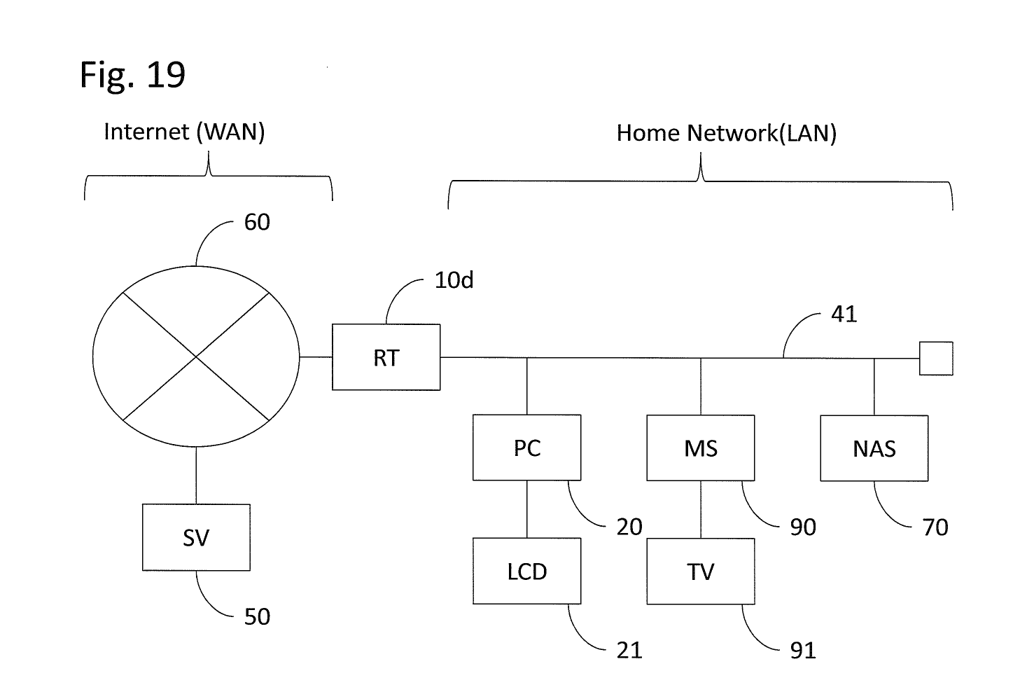

Next, a modification of this embodiment will be described in detail with reference to the drawings. FIG. 19 is a diagram illustrating a network system according to this modification. In the second embodiment, the NAS 70 accesses the router 10d in the same intranet 40, and sets its language environment. In this modification, a media server 90 accesses a router or a NAS in a common home network 41 and sets its language environment. In FIG. 19, the media server 90 is connected to the home network 41. To the media server 90, a television 91 is connected. The media server 90 reads video data stored in the computer 20 (at start-up) or in the NAS 70, and plays back video data on the television 91.

In this embodiment, the NAS 70 may have the configuration of any of the NAS's 70a to 70c. Also, the NAS 70 may further include, in addition to the configuration of any of the NAS's 70a to 70c, the language data transmitting section 15 included in the router 10d (for convenience of explanation, a NAS having such a configuration is hereinafter referred to as a NAS 70d). The media server 90 has the configuration of whichever of the NAS 70 or NAS's 70a to 70d.

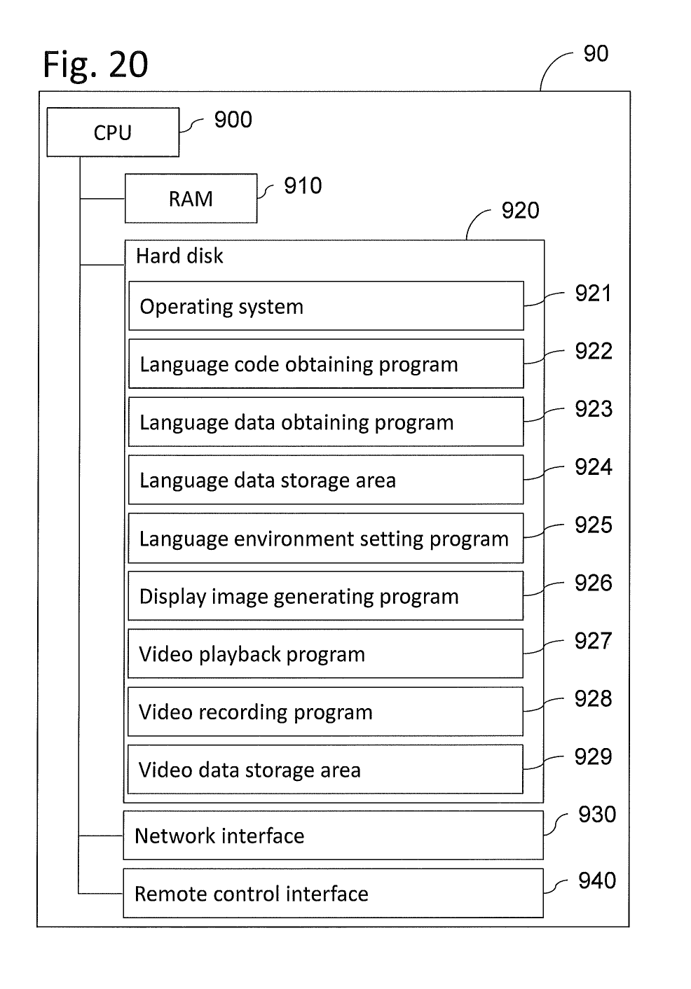

FIG. 20 is a system configuration diagram of the media server 90. The media server 90 includes a CPU 900, a RAM 910, a hard disk 920, a network interface 930, and a remote control interface 940. The hard disk 920 includes an operating system (OS) 921, a language code obtaining program 922, a language data obtaining program 923, a language data storage area 924, a language environment setting program 925, a display image generating program 926, a video playback program 927, a video recording program 928, and a video data storage area 929. These programs are executed by the CPU 900, to realize their functions. Those components which have the same names as those in the first and second embodiments have the same functions as those in the first and second embodiments, respectively. Thus, no description thereof will be given. The remote control interface 940 receives, from a remote controller (not shown), setting and operational information performed in the media server 90. The video playback program 927 plays back video data stored in the video data storage area 929, the NAS 70, or the computer 20 (only at start-up of the computer 20). The video recording program 928 stores video data into the video data storage area 929, the NAS 70, or the computer 20 (only at start-up of the computer 20).

When the media server 90 becomes connected to the home network 41, the media server 90 accesses other online devices connected to the home network 41 such as the computer 20, the router 10d, or the like thereby to obtain a language code. At this time, the user of the media server 90 can set or operate the media server 90 using a remote controller (not shown), for example. Operations thereafter are the same as those in step S100 and thereafter in FIG. 3, and thus no detailed description thereof will be given.

In the first and second embodiments, when the router 10 or the NAS 70 is accessed by the computer 20, it obtains a language code from the computer 20, and sets the language environment. However, when the router 10 becomes connected to the intranet 40, for example, the language data obtaining section may access other online devices connected to the intranet 40 thereby to obtain a language code from the other online devices. For example, in the second embodiment, when the NAS 70 becomes connected to the intranet 40, the language data obtaining section may access the router 10d, obtain the language code used in the router 10d, and then obtain the language data.

Further, in the above embodiments, the router, NAS, and media server have been described as examples of the language setting devices. However, language setting devices suitable for the present invention are not limited to those described in the embodiments. In addition to routers, NAS's, and media servers, suitable apparatuses include wireless HUBs, device servers, print servers, digital photo frames, network cameras, and network recorders.

The programs described in the above-described embodiments may be distributed stored in a storage medium such as a CD-ROM. Alternatively, the programs may be stored in a server connected to a network thereby to be downloaded by the language setting devices.

The above embodiments are described for easy understanding of the present invention, and should not be deemed to limit the present invention. It will be understood that the present invention may be changed and modified within the scope of the present description and the appended claims, and that the present invention includes equivalents thereto.

What is claimed is:

1. A language setting device connectable to a network for enabling its language environment to be set, the device comprising:
a language code obtaining section configured to obtain from an online device connected to the network a language code indicating what language environment the online device uses;
a language data obtaining section configured to obtain, from a language data storage server in the network, language data for configuring the language setting device to have a language environment corresponding to the language code obtained by the language code obtaining section;
a storage section configured to store the language data obtained by the language data obtaining section; and
a language environment setting section configured to use the language data stored in the storage section to set the language environment of the language setting device.

2. The language setting device according to claim 1, wherein the network includes an LAN and an internet, the language setting device is connected to both the LAN and the internet, and the language data storage server is connected to at least one of either the internet or the LAN, the language data obtaining section therein being further configured:
to search either the network of the internet or the network of the LAN for the language data storage server;
to obtain, if the language data storage server has been found in one of either of the networks, the language data from the language data storage server that the language data obtaining section has found;
to search, if the language data storage server has not been found in one of either of the networks, the other of the networks for the language data storage server; and
to obtain, if the language data storage server has been found in the other of the networks, the language data from the language data storage server that the language data obtaining section has found.

3. The language setting device according to claim 1, further comprising a language data transmitting section for transmitting the language data to another language setting device on the network.

4. The language setting device according to claim 1, further comprising:
a Web server communication function using the World-Wide Web, wherein
the language code obtaining section is further configured to obtain, from an online device accessing the Web server via a Web browser, a language code indicating in what language environment the Web browser operates.

5. A language data storage server for storing language data used for setting a specific language environment of a language setting device connected to a network for enabling its language environment to be set, and for transmitting the language data to the language setting device in response to a request from the language setting device.

6. A language environment configuration system for configuring network device language environments, the system comprising:
a language setting device whose language environment is to be configured; and
a language data storage server for transmitting language data to the language setting device to set the language environment of the language setting device to a specific language environment; wherein
the language setting device includes:
a language code obtaining section configured to obtain from an online device connected to the network a language code indicating what language environment the online device uses;
a language data obtaining section configured to obtain, from a language data storage server in the network, language data for configuring the language setting device to have a language environment corresponding to the language code obtained by the language code obtaining section;
a storage section configured to store the language data obtained by the language data obtaining section; and
a language environment setting section configured to use the language data stored in the storage section to set the language environment of the language setting device.

7. A method for setting language of a language setting device connected to a network, the method comprising:
obtaining from an online device connected to the network a language code indicating what language environment the online device uses;
obtaining, from a language data storage server in the network, language data for configuring the language setting device to have a language environment corresponding to the language code obtained by the language code obtaining section; and
setting the language environment of the language setting device to have the language environment the online device uses, based on the obtained language data.

8. A non-transitory storage medium having stored therein a language setting program for setting language of a language setting device connected to a network, the program causing a computer provided in the language setting device to execute the steps of:
obtaining from an online device connected to the network a language code indicating what language environment the online device uses;
obtaining, from a language data storage server in the network, language data for configuring the language setting device to have a language environment corresponding to the language code obtained by the language code obtaining section; and
setting the language environment of the language setting device to have the language environment the online device uses, based on the obtained language data.
